(19) United States
(12) Patent Application Publication
(10) Pub. No.: US 2024/0385359 A1
(43) Pub. Date: Nov. 21, 2024

(54) OPTICAL ELEMENT AND OPTICAL APPARATUS

(71) Applicant: CANON KABUSHIKI KAISHA, Tokyo (JP)

(72) Inventor: Yui MIZUTANI, Saitama (JP)

(21) Appl. No.: 18/640,038

(22) Filed: Apr. 19, 2024

(30) Foreign Application Priority Data
May 16, 2023 (JP) 2023-081101

(51) Int. Cl. G02B 5/30

(52) U.S. Cl. CPC G02B 5/3058

(57) ABSTRACT

An optical element includes a base material having a plurality of convex portions arranged along a first direction, and a conductor provided to each of the plurality of convex portions. Each of the plurality of convex portions extends in a second direction perpendicular to the first direction. In a section including the first direction and a third direction perpendicular to each of the first direction and the second direction, each of the plurality of convex portions has a rectangular shape. Predetermined inequalities are satisfied.

### BACKGROUND

### Technical Field

One of the aspects of the embodiments relates to an optical element and an optical apparatus.

### Description of Related Art

An optical apparatus including an observation optical system such as a head mount display (HMD) and an electronic viewfinder (EVF) is demanded to have a reduced size. Japanese Patent Laid-Open No. 2021-81530 discloses an observation optical system (VR optical system) using two half-transmissive surfaces. In Japanese Patent Laid-Open No. 2021-81530, a film-shaped wire grid polarizer is used as a polarization-selective transmissive reflective element on one of the two half-transmissive surfaces. Japanese Patent Laid-Open No. 2010-39183 discloses a method of manufacturing a film-shaped wire grid polarizer by forming a lattice-shaped concavo-convex (uneven) structure while winding up a base film wound into a roll shape, and by depositing metal while changing a deposition angle using oblique deposition.

The film-shaped wire grid polarizer disclosed in Japanese Patent Laid-Open No. 2021-81530 or 2010-39183 is to adhere to the surface of an optical element such as a lens with a desired surface precision, but the adhering process is arduous. Therefore, it is demanded to form a wire grid (fine conductor wire) directly on the optical element. As disclosed in Japanese Patent Laid-Open No. 2010-39183, in order to form the wire grid, the optical element after vapor deposition is immersed in an acid or alkaline solution to remove unnecessary portions of the conductor. However, in a case where the optical element is immersed in an acid or alkaline solution in forming the wire grid directly on an optical element, the optical performance of the optical element may deteriorate, such as fogging.

### SUMMARY

An optical element according to one aspect of the disclosure includes a base material having a plurality of convex portions arranged along a first direction, and a conductor provided to each of the plurality of convex portions. Each of the plurality of convex portions extends in a second direction perpendicular to the first direction. In a section including the first direction and a third direction perpendicular to each of the first direction and the second direction, each of the plurality of convex portions has a rectangular shape. The following inequalities are satisfied:

$$125 \leq P \leq 160$$

$$0.45 \leq Dx / Dz \leq 1.2$$

where P (mm) is an arrangement pitch of the plurality of convex portions, Dz (nm) is a distance in the third direction from a top surface of each convex portion in the section to a top surface of the conductor provided to each convex portion, and Dx (nm) is a thickness of the conductor in the first direction at half a height in the third direction of each convex portion. An optical apparatus including the above optical element also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a front view of a transmissive reflective element according to each example.

FIG. 2 is a partially enlarged sectional view of the transmissive reflective element according to each example.

FIG. 3 is a side view of the transmissive reflective elements according to Examples 1, 5, and 6.

FIG. 4 is a partially enlarged sectional view of the transmissive and reflective elements according to Examples 1, 5, and 6.

FIG. 5 illustrates the transmittance and reflectance in Example 1.

FIG. 6 is a partially enlarged sectional view of a transmissive reflective element according to a comparative example.

FIG. 7 illustrates transmittance and reflectance in the comparative example.

FIG. 8 is a side view of the transmissive element according to Example 2.

FIG. 9 illustrates the transmittance and reflectance in Example 2.

FIG. 10 is a side view of a transmissive reflective element according to Example 3.

FIG. 11 illustrates the transmittance and reflectance in Example 3.

FIG. 12 is a side view of a transmissive element according to Example 4.

FIG. 13 illustrates the transmittance and reflectance in Example 4.

FIG. 14 illustrates the transmittance and reflectance in Example 5.

FIG. 15 illustrates the transmittance and reflectance in Example 6.

FIG. 16 is a sectional view of an optical system according to Example 7.

FIG. 17 is a sectional view of an observation apparatus according to Example 8.

FIG. 18 is an external view of the observation apparatus according to Example 8.

### DESCRIPTION OF THE EMBODIMENTS

Referring now to the drawings, a detailed description will be given of examples according to the present disclosure.

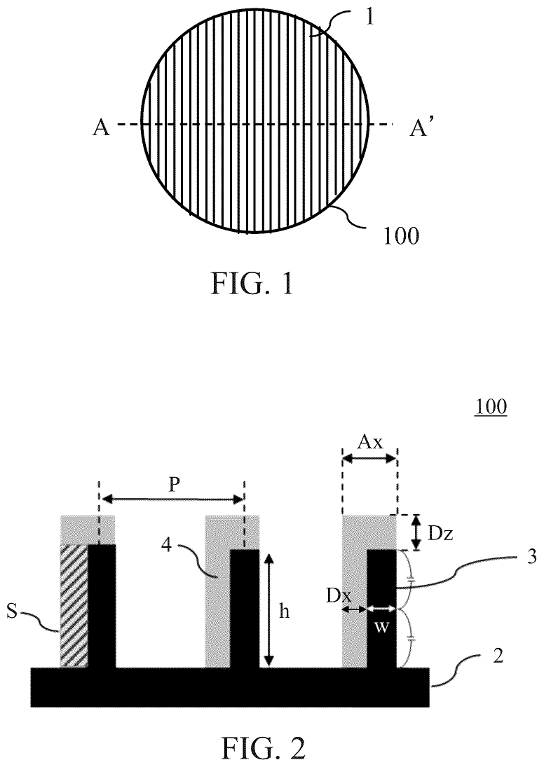

Referring now to FIGS. 1 and 2, a description will be given of a transmissive reflective element (polarization-selective transmissive reflective element, optical element) 100 according to each example. FIG. 1 is a front view of the transmissive reflective element 100. In FIG. 1, a horizontal direction is set to an X(-axis) direction (first direction), and a vertical direction is a Y(-axis) direction (second direction). FIG. 2 is a partially enlarged sectional view of the transmissive reflective element 100, and schematically illustrates an enlarged part of the sectional shape of the transmissive reflective element 100 in FIG. 1 taken along a line A-A′. In FIG. 2, a horizontal direction corresponds to the X direction (first direction), a vertical direction corresponds to a Z(-axis) direction (third direction), and a depth direction corresponds to the Y direction (second direction). The concavo-convex structure illustrated in FIG. 2 extends in one direction (second direction). Extending in one direction does not necessarily mean that the concavo-convex structure extends strictly in parallel; it is sufficient that they extend substantially in parallel.

As illustrated in FIG. 1, a plurality of thin conductor wires 1 extending in the vertical direction are formed on one surface of the transmissive reflective element 100. As illustrated in FIG. 2, the transmissive reflective element 100 includes a base material (substrate) 2, convex portions 3 formed on the base material 2 using the same material as that of the base material 2, and conductors 4 each formed on a vertex portion (top surface) and side surface (left side surface) of the convex portion 3. That is, on the surface of the base material 2, a plurality of convex portions 3 are arranged along the first direction (horizontal direction in FIGS. 1 and 2) at a predetermined pitch (arrangement pitch, pitch P). The conductor 4 in FIG. 2 corresponds to the thin conductor wire in FIG. 1.

The conductor 4 covers at least a part of each of the plurality of convex portions 3. More specifically, the conductor 4 covers at least a part of one side (left side) and the top surface of each of the plurality of convex portions 3 in the section (XZ plane) illustrated in FIG. 2. The conductor 4 may cover 60% or more of the top surface of each of the plurality of convex portions 3 in the section of FIG. 2. In each example, the conductor 4 is not formed on the right side of the convex portion 3, but this embodiment is not limited to this example, and the conductor 4 may be formed on both the left and right sides of the convex portion 3.

Each of the base material 2 and the convex portions 3 is made, for example, of a thermoplastic resin. For example, the base material 2 and the convex portions 3 can be integrally molded by injection molding of a thermoplastic resin using a lens mold having a concavo-convex structure on its surface. Alternatively, the base material 2 and the convex portions 3 may be a lattice formed on the lens surface by applying an ultraviolet curing resin to the lens surface and pressing a mold onto the lens surface. The surface shape of the base material 2 is not limited to a flat surface, but may be a curved surface. By integrating the base material 2 and the convex portions 3, the process of adhering the transmissive reflective element 100 to an optical element such as a lens becomes unnecessary, and disadvantages such as increased manufacturing costs or element defects especially due to a curved surface can be reduced.

The base material 2 may be made of any material as long as it is transparent in the target wavelength range, and the material examples include rylate resin (Polymethylmethacrylate: PMMA), polycarbonate resin (PC), cycloolefin resin (COP), cycloolefin copolymer (COC), and polystyrene resin (PS) etc. In order to avoid deterioration of the polarization separating function, the phase change in the light beam may be reduced at the used wavelength, and a low birefringence material may be used.

The thickness of the base material 2 may be set to 100 μm or more so that the transmissive reflective element 100 can be easily held in a case where it is incorporated into an optical system including a plurality of lenses, for example. For example, the base material 2 is a flat plate with a thickness on the optical axis of 100 μm or more or a lens having a curved surface.

The sectional shape of the convex portion 3 may be rectangular in the section (XZ plane) illustrated in FIG. 2. That is, in a section including the first direction and a third direction orthogonal to each of the first direction and the second direction, each of the plurality of convex portions 3 has a rectangular shape. Here, the rectangle may have repeated concave and convex shapes, and is not limited to a mathematically strict rectangle, and its shape may have blunted upper corners of the convex portion 3 or a hem at the bottom of the convex portion 3. However, in order to achieve high polarization separating performance, the top surface of the convex portion 3 may have a flat region with a width of at least 1/10 or more, or ⅕ or more of the width at 50% of the height of the convex portion 3.

Each example satisfies the following inequality (1):

$$125 \leq P \leq 160 \qquad ( 1 )$$

where the pitch P (nm) of the plurality of convex portions 3.

In general, a wire grid polarizer exhibits better polarization separating performance in a wider wavelength range as the pitch P of the conductors 4 becomes smaller. In a case where the pitch P is larger than the target wavelength, unnecessary light will be generated due to diffraction and the polarization separating performance deteriorates. Therefore, in order to exhibit high polarization separating performance in the visible region, the pitch P may be 160 nm or less.

In order to form a fine and highly concavo-convex (uneven or undulate) structure with a ratio h/w described below, the pitch P may be 125 nm or more. In a case where pitch P is 125 nm or less, the half maximum full-width (HMFW) w of the convex portion 3 is to be 20 nm or less so as to maintain a relationship between the pitch P and the maximum thickness Ax of the conductor 4 in the horizontal direction in a region above the top surface of the convex portion 3, which will be described below.

Inequality (1) may be replaced with the following inequality (1a):

$$125 \leq P \leq 158 \qquad ( 1 a )$$

Inequality (1) may be replaced with the following inequality (1b):

$$125 \leq P \leq 156 \qquad ( 1 b )$$

Each example has difficulty in independently controlling the height of the conductor 4 deposited above the top surface of the convex portion 3 in order to obtain the thin conductor wire 1 by obliquely depositing the conductor 4 on the convex portion 3 at a fixed angle. Therefore, the height of the conductor 4 depends on the height h of the convex portion 3. Since the wire grid polarizer exhibits excellent polarization separating performance in a case where the conductor 4 has a certain height or more, the height h of the convex portion 3 may be similarly high. Therefore, the height h (nm) of the convex portion 3 may satisfy the following inequality (2):

$$100 \leq h \qquad ( 2 )$$

By increasing the height h of the convex portion 3, the area where the conductor 4 comes into close contact with the side surface of the convex portion 3 increases, and the adhesion performance improves.

Inequality (2) may be replaced with the following inequality (2a):

$$100 \leq h \leq 1000 \qquad ( 2 a )$$

Inequality (2) may be replaced with the following inequality (2b):

$$100 \leq h \leq 500 \qquad ( 2 b )$$

Inequality (2) may be replaced with the following inequality (2c):

$$100 \leq h \leq 200 \qquad ( 2 c )$$

In a case where the conductor 4 is obtained by the above method, the maximum thickness Ax in the horizontal direction (first direction) of the conductor 4 in the region above the top surface of the convex portion 3 depends on the width of the convex portion 3. As will be described in detail below, in order to obtain excellent polarization separating performance, the maximum thickness Ax of the conductor 4 in the horizontal direction in the region above the top surface of the convex portion 3 is to be controlled. Thus, the HWFM w of the convex portion 3 (the width at the 50% height position of the convex portion 3) may be small. As described above, the height h of the convex portion 3 may be 100 nm or more. The ratio h/w between the HWFM w and the height h of the convex portion 3 may be high. However, in a case where the fine convex portion 3 may have an HWFM w of 20 nm or less, defects such as deformation or “cracking” can occur during mold release in the injection molding process. In consideration of moldability, the ratio h/w between the HWFM w and the height h of the convex portion 3 may satisfy the following inequality (3):

$$4.0 \leq h / w \leq 9. \qquad ( 3 )$$

Inequality (3) may be replaced with the following inequality (3a):

$$4.5 \leq h / w \leq 8.5 \qquad ( 3 a )$$

Inequality (3) may be replaced with the following inequality (3b):

$$5. \leq h / w \leq 8. \qquad ( 3 b )$$

The conductor 4 may be made of a material with high reflectance in the visible light region. The conductor 4 may be made, for example, of aluminum, silver, gold, chromium, zirconium, titanium, copper, tungsten, magnesium, tantalum, platinum, or an alloy containing these as main components.

The thin conductor wire 1 is formed by depositing the conductor 4 on the convex portion 3 having the concavo-convex structure. The method for depositing the conductor 4 on the convex portion 3 is not particularly limited as long as the conductor 4 can be deposited on the convex portion 3, such as a vacuum evaporation method or a sputtering method. For example, the oblique deposition method may be used in the vacuum evaporation method because the deposition angle can be properly set according to the shape or pitch of the convex portion 3, and the shape of the conductor 4 can be easily controlled. Here, the deposition angle is an angle between a direction in which the convex portion 3 is erected and the deposition source (angle θ illustrated in FIG. 4).

The oblique deposition at a fixed angle may be used because the oblique deposition produces an excellent polarization separating function and the manufacturing cost is low. Accordingly, using deposition simulation and strictly coupled wave analysis, the condition range for achieving high polarization separating performance may be determined by the oblique deposition at a fixed angle. As a result, the following inequalities can be achieved.

In each example, in a case where the conductor 4 attached to the side surface of the convex portion 3 is thin in the horizontal direction, the polarization separation becomes difficult. The following inequality (4) be satisfied:

$$20.00 \leq Dx \qquad ( 4 )$$

where Dx (mm) is a thickness in the horizontal direction of the conductor 4 at half the height of the convex portion 3 (for each of the plurality of convex portions 3, the thickness in the first direction of the conductor 4 at a position corresponding to half the height of the convex portion 3 in the third direction).

Inequality (4) may be replaced with the following inequality (4a):

$$20.2 \leq Dx \qquad ( 4 a )$$

Inequality (4) may be replaced with the following inequality (4b):

$$20.4 \leq Dx \qquad ( 4 b )$$

In each example, Dz (nm) is the maximum height of the conductor 4 in the region above the convex portion 3 (height in the Z direction of the conductor 4 from the top surface of the convex portion 3 in the section). In other words, Dz is a distance in the third direction from the top surface of the convex portion 3 to the top surface of the conductor 4 provided on the convex portion 3 in a section including the third direction and the first direction for each of the plurality of convex portions 3. At this time, excellent polarization separating performance can be obtained in a case where the ratio Dx/Dz satisfies the following inequality (5):

$$0.45 \leq Dx / Dz \leq 1.2 \qquad ( 5 )$$

Inequality (5) may be replaced with the following inequality (5a):

$$0.46 \leq Dx / Dz \leq 1.15 \qquad ( 5 a )$$

Inequality (5) may be replaced with the following inequality (5b):

$$0.47 \leq Dx / Dz \leq 1.1 \qquad ( 5 b )$$

In each example, in a case where the top surface of the convex portion 3 or the conductor 4 is not a strictly flat surface, the maximum value of each height (distance) can be used as each height (distance).

In each example, the maximum thickness Ax in the horizontal direction and the pitch P of the conductor 4 above the top surface of the convex portion 3 may satisfy the following inequality (6). Satisfying inequality (6) can provide better polarization separating performance.

$$0.25 \leq Ax / P \leq 0.6 \qquad ( 6 )$$

Inequality (6) may be replaced with the following inequality (6a):

$$0.25 \leq Ax / P \leq 0 \text{.58} \qquad ( 6 a )$$

Inequality (6) may be replaced with the following inequality (6b):

$$0.26 \leq Ax / P \leq 0 \text{.56} \qquad ( 6 b )$$

In a case where the value Ax/P, which is a ratio of the maximum thickness Ax of the conductor 4 to the pitch P expressed by inequality (6), becomes lower than the lower limit value of inequality (6), the transmittance becomes high and a transmissive reflective element with high transmittance can be provided. However, as the transmittance becomes higher, the transmittance of unnecessary light also increases, the polarization separating performance deteriorates, and it becomes difficult to obtain a polarization-selective half-transmissive element with high contrast. On the other hand, in a case where the value of Ax/P becomes higher than the upper limit of inequality (6), the transmittance of S-polarized light is suppressed, and thus a polarization-selective half-transmissive element may be obtained that exhibits an excellent polarization separating function and has high contrast. However, the transmittance decreases, and it becomes difficult to provide a transmissive reflective element with high transmittance. Thus, the characteristic of the polarization selective half-transmissive element can be controlled according to the purpose of use by changing the shape of the conductor 4.

In the oblique deposition at a fixed angle, a range of the deposition angle that forms the shape of the suitable (or optimal) conductor 4 is determined for exhibiting excellent polarization separating performance according to the height h of the convex portion 3, the HWFM w of the convex portion 3, or the pitch P. Here, the suitable shape of the conductor 4 may be a shape in which the conductor 4 is deposited from the bottom (bottom surface) of the concave portion in the concavo-convex structure to a portion above the top surface of the convex portion 3, as illustrated in FIG. 2, but the suitable shape of the conductor 4 may not have to be exactly this shape.

However, at an angle larger than the deposition angle, the conductor 4 may not be deposited at the bottom of the concave portion due to shielding by the adjacent convex portions 3 and the conductor 4 may become lower, or the conductor 4 deposited on the side surface of the convex portion 3 becomes thick and may come into contact with a portion on the top surface of the adjacent convex portion 3 of the adjacent conductor 4. On the other hand, at an angle smaller than the deposition angle, metal adheres to the concave portion between the convex portions 3. Therefore, either case may cause the polarization separating performance to deteriorate. In addition, in forming the thin conductor wire 1 directly on the surface of the optical element, in a case where the concavo-convex structure is immersed in an alkali or acid solution to eliminate contact between adjacent conductors 4 or to remove the conductor 4 adhered to the concave portion, the quality of the lens may deteriorate, such as fogging on the optical element. Therefore, as illustrated in FIG. 2, the conductor 4 may have a shape that extends from the bottom of the concave portion of the concavo-convex structure in the height direction of the convex portion 3 and covers the top surface of the convex portion 3.

The conductor 4 in the region above the top surface of the convex portion 3 may cover 60% or more of the top surface of the convex portion 3. A relationship between the maximum height Dz of the conductor 4 in the region above the top surface of the convex portion 3 and the height h of the convex portion 3 may satisfy the following inequality (7):

$$0.15 \leq Dz / h \leq 0 \text{.60} \qquad ( 7 )$$

Inequality (7) may be replaced with the following inequality (7a):

$$0.17 \leq Dz / h \leq 0 \text{.55} \qquad ( 7 a )$$

Inequality (7) may be replaced with the following inequality (7b):

$$0.19 \leq Dz / h \leq 0 \text{.50} \qquad ( 7 b )$$

In the section of FIG. 2, the ratio S/A may satisfy the following inequality (8):

$$0.50 \leq S / A \qquad ( 8 )$$

where S is an area of the portion of the conductor 4 that adheres to the side surface of the convex portion 3 (hatched area in FIG. 2), and A is an area of the entire conductor 4 (inverted L-shaped area, that is, the sum of the area S and the area of the area of the conductor 4 above the convex portion 3).

Inequality (8) may be replaced with the following inequality (8a):

$$0.52 \leq S / A \leq 0 \text{.90} \qquad ( 8 a )$$

Inequality (8) may be replaced with the following inequality (8b):

$$0.59 \leq S / A \leq 0 \text{.80} \qquad ( 8 b )$$

By satisfying these inequalities, the suitable (or optimal) deposition angle is satisfied in the deposition at a fixed angle, so that the shape of the conductor 4 that exhibits excellent polarization separating performance can be formed. Each example will be described in detail below.

### EXAMPLE 1

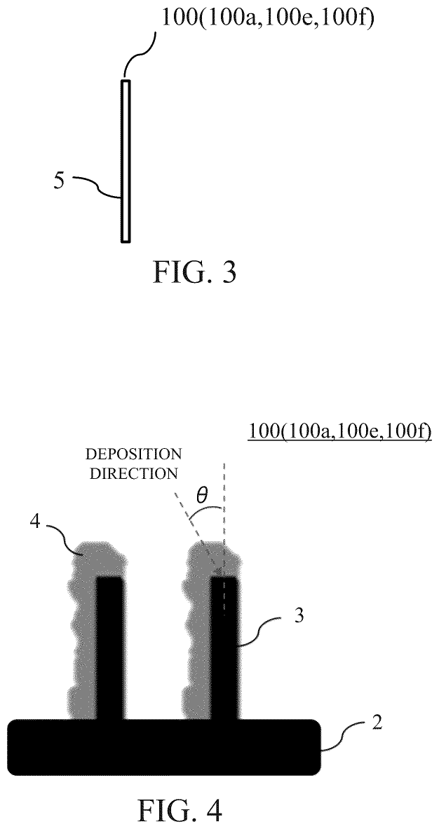

Referring now to FIGS. 3 to 5, a description will be given of a transmissive reflective element 100 (100a) according to Example 1. FIG. 3 is a side view of the transmissive reflective element 100 (100a). FIG. 4 is a partially enlarged sectional view of the transmissive reflective element 100 (100a).

The transmissive reflective element 100 has thin conductor wires 1 on a thin conductor wire surface 5 on one side of a base material 2 made of a flat plate with a thickness of 100 μm. Each of the base material 2 and convex portions 3 is made of a cycloolefin copolymer. The pitch P of the convex portions 3 is 130 nm, and the convex portions 3 have a periodic structure with a height h of 170 nm, an HWFM w of 25 nm, and a rectangular sectional shape. The conductor 4 is made of aluminum, and the shape of the conductor 4 illustrated in FIG. 4 is obtained in an oblique deposition simulation at an angle (deposition angle) θ of 29 degrees between the extension direction of the vertical portion of the convex portion 3 and the deposition direction. The conductor 4 has a shape such that the conductor 4 is deposited on the side surface of the convex portion 3 so as to extend from the bottom of the concave portion in the concavo-convex structure to a portion above the convex portion 3, and the conductor 4 is deposited on the entire top surface of the convex portion 3. The shape of the conductor 4 obtained by the deposition simulation and the actually deposited shape of the conductor 4 are similar.

Since FIG. 2 schematically illustrates the shape of the conductor 4, it has a rectangular shape with a flat surface. Actually, in a case where the conductor 4 is deposited on the convex portion 3, scattered particles adhere and accumulate, so that the surface of the conductor 4 has a rough shape as illustrated in FIG. 4.

In this example, the maximum height Dz of the conductor 4 in the region above the top surface of the convex portion 3 is 42.86 nm, and the thickness Dx in the horizontal direction of the conductor 4 at half the height of the convex portion 3 is 23.76 nm, and a ratio between them Dx/Dz is 0.55. The maximum thickness Ax in the horizontal direction of the conductor 4 above the top surface of the convex portion 3 is 48.76 nm, and the area S of the conductor 4 deposited on the side surface of the convex portion 3 is 0.66 nm². Here, the area S is the area of the conductor 4 deposited on the side surface of the convex portion 3, as hatched in FIG. 2. Each of the above numerical values is an average numerical value, and can actually be found from the average value of three adjacent shapes in a single arbitrary section, for example.

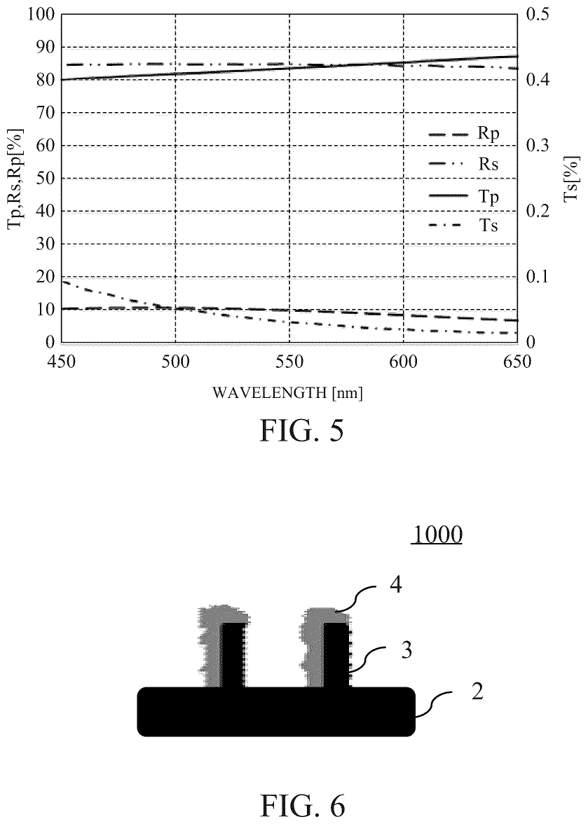

FIG. 5 illustrates a rigorous coupled-wave analysis (RCWA) result using the above structure obtained in the oblique deposition simulation, and illustrates transmittance and reflectance. In FIG. 5, the horizontal axis illustrates wavelength (nm), and the vertical axis illustrates transmittance (%) or reflectance (%), respectively. Tp (%) represents the transmittance of P-polarized light, Ts (%) represents the transmittance of S-polarized light, Rp (%) represents the reflectance of P-polarized light, and Rs (%) represents the reflectance of S-polarized light. In FIG. 5, since the value of Ts is small, only Ts is illustrated on the right vertical axis. The RCWA result of the transmissive reflective element 100 (100a) obtained in the deposition simulation, and actually measured values of the transmittance and reflectance of P-polarized light and S-polarized light of the polarization-selective half-transmissive element actually created by the deposition at the same angle are similar.

In this example, the polarization degree at a wavelength of 550 nm, where human visibility is high, is 99.92%, and excellent polarization separating performance is obtained. Here, the polarization degree can be calculated from the following equation (9):

$$[ ( Tp - Ts ) / ( Tp + Ts ) ] \times 100 \qquad ( 9 )$$

In a case where this example is applied to an HMD, etc., a high-contrast image due to the high polarization degree can be provided.

### Comparative Example

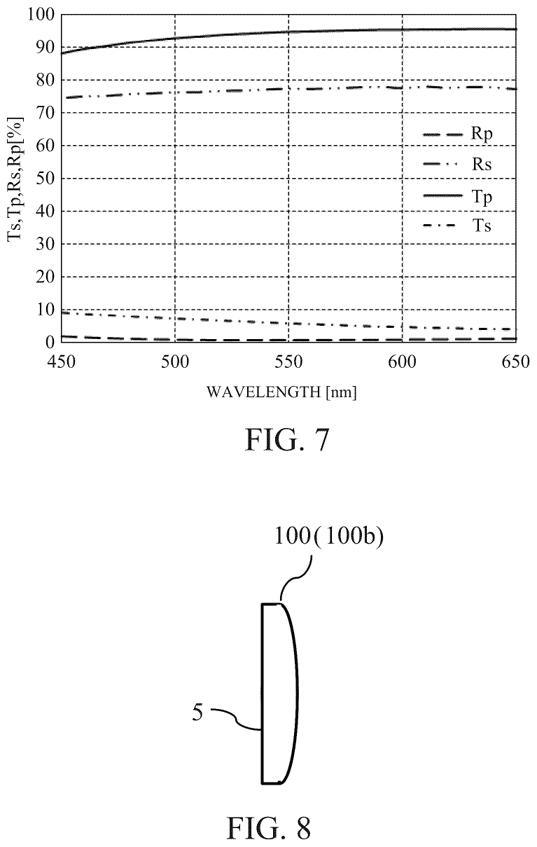

Referring now to FIGS. 6 and 7, a description will now be given of a transmissive reflective element (polarization-selective transmissive reflective element) 1000 according to a comparative example having no convex portion 3 or conductor 4 described in Example 1. In this comparative example, similarly to Example 1, the flat base material 2 and convex portions 3 are made of a cycloolefin copolymer.

FIG. 6 is a partially enlarged sectional view of the transmissive reflective element 1000 according to this comparative example. The pitch P of the convex portions 3 is 130 nm, and the convex portions 3 have a periodic structure with a height h of 60 nm, an HWFM w of 25 nm, and a rectangular sectional shape. The conductor 4 is made of aluminum, and the following shape of the conductor 4 is obtained in an oblique deposition simulation at an angle of 58 degrees.

In this comparative example, the maximum height Dz of the conductor 4 in the region above the top surface of the convex portion 3 is 15.90 nm, the thickness Dx in the horizontal direction of the conductor 4 at half the height of the convex portion 3 is 25.44 nm, and a ratio between them Dx/Dz is 1.60. The maximum thickness Ax in the horizontal direction of the conductor 4 above the top of the convex portion 3 is 50.44 nm, and the area S of the conductor 4 on the side surface of the convex portion 3 is 0.66 nm 2.

FIG. 7 illustrates an RCWA result in this comparative example. The transmittance of S-polarized light is high, excellent polarization separating cannot be obtained, and the polarization degree at a wavelength of 550 nm is 88.46%. Since the height h of the convex portion 3 is low, the height of the conductor 4 is also low. Since the deposition angle for forming the suitable shape of the conductor 4 increases, the conductor 4 deposited on the side surface of the convex portion 3 is thicker than the conductor 4 deposited on the top surface of the convex portion 3. Therefore, inequality (5) is not satisfied and the polarization degree is low.

### EXAMPLE 2

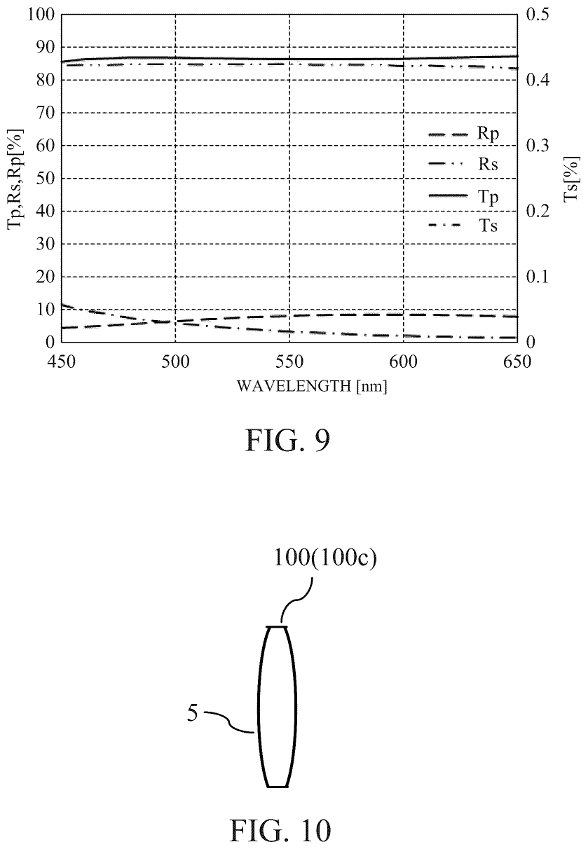

Referring now to FIGS. 8 and 9, a description will be given of a transmissive reflective element 100 (100b) according to Example 2. FIG. 8 is a side view of the transmissive reflective element 100 (100b). The transmissive reflective element 100 (100b) has thin conductor wires 1 on a surface on a flat surface side (thin conductor wire surface 5) of a base material 2 made of a plano-convex lens with a thickness of 0.8 mm.

In this example, each of the base material 2 and the convex portions 3 is made of a cycloolefin copolymer. The pitch P of the convex portions 3 is 130 nm, the height h of the convex portion 3 is 200 nm, the HWFM w of the convex portion 3 is 25 nm, and the sectional shape of the convex portion 3 is rectangular. The conductor 4 is made of aluminum. In an oblique deposition simulation at an angle of 26 degrees, the conductor 4 has a shape such that the conductor 4 is deposited on the side surface of the convex portion 3 so as to extend upward from the bottom of the concave portion in the concavo-convex structure to a portion above the convex portion 3, and the conductor 4 is deposited on the entire top surface of the convex portion 3.

The maximum height Dz of the conductor 4 in the region above the top surface of the convex portion 3 is 43.14 nm, the thickness Dx in the horizontal direction of the conductor 4 at half the height of the convex portion 3 is 21.04 nm, and a ratio between them Dx/Dz is 0.49. The maximum thickness Ax in the horizontal direction of the conductor 4 above the top surface of the convex portion 3 is 46.04 nm, and the area S of the conductor 4 on the side surface of the convex portion 3 is 0.68 nm².

FIG. 9 illustrates an RCWA result in this example, and illustrates transmittance and reflectance. In FIG. 9, since the value of Ts is sufficiently small, only Ts is illustrated on the right vertical axis. Based on this result, the polarization degree at a wavelength of 550 nm is calculated to be 99.96%.

### EXAMPLE 3

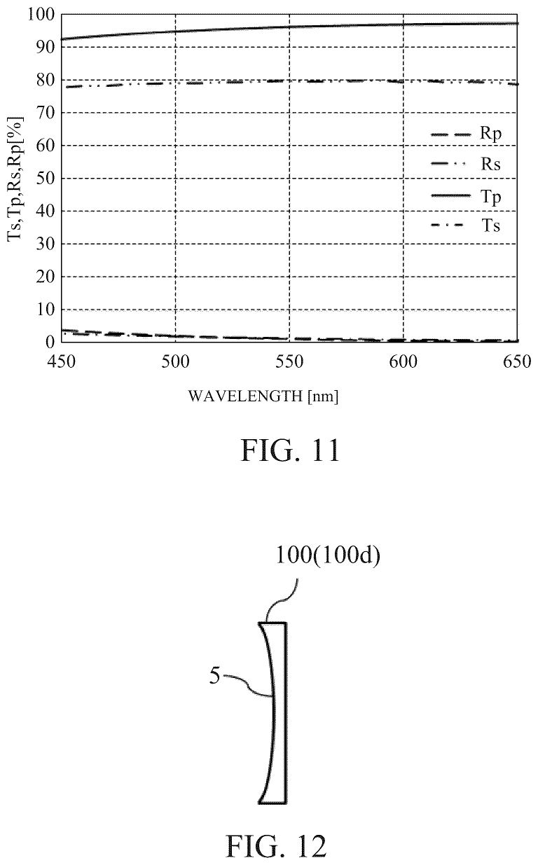

Referring now to FIGS. 10 and 11, a description will be given of a transmissive reflective element 100 (100c) according to Example 3. FIG. 10 is a side view of the transmissive reflective element 100 (100c). The transmissive reflective element 100 (100c) has thin conductor wires 1 on a thin conductor wire surface 5 of a base material 2 made of a biconvex lens having a thickness of 0.8 mm.

Each of the base material 2 and convex portions 3 is made of a cycloolefin copolymer. The pitch P of the convex portions 3 is 130 nm, the height h of the convex portion 3 is 110 nm, the HWFM w of the convex portion 3 is 15 nm, and the sectional shape of the convex portion 3 is rectangular. The conductor 4 is made of aluminum. In an oblique deposition simulation at an angle of 43 degrees, the conductor 4 has a shape such that the conductor 4 is deposited on the side surface of the convex portion 3 so as to extend upward from the bottom of the concave portion in the concavo-convex structure to a portion above the convex portion 3, and the conductor 4 is deposited on the entire top surface of the convex portion 3.

The maximum height Dz of the conductor 4 in the region above the top surface of the convex portion 3 is 21.94 nm, the thickness Dx in the horizontal direction of the conductor 4 at half the height of the convex portion 3 is 20.46 nm, and a ratio between them Dx/Dz is 0.93. The maximum thickness Ax in the horizontal direction of the conductor 4 above the top surface of the convex portion 3 is 35.46 nm, and the area S of the conductor 4 on the side surface of the convex portion 3 is 0.74 nm².

FIG. 11 illustrates an RCWA result in this example, and illustrates transmittance and reflectance. Based on this result, the polarization degree at a wavelength of 550 nm is calculated to be 96.83%.

In this example, the value of Ax/P, which is the ratio of the conductors 4 to the pitch P expressed by inequality (6), is close to the lower limit. In a case where this value is small, the transmittance can be increased, so in a case where the transmissive reflective element 100 (100c) according to this example is used in an observation optical system such as an HMD, a bright image can be provided. However, the transmittance of S-polarized light also increases, the polarization separating performance deteriorates, and the contrast decreases. Since the transmittance of S-polarized light is suppressed to 5% or less over the wavelength range of 450 nm to 650 nm, the influence on the observed image is small.

### EXAMPLE 4

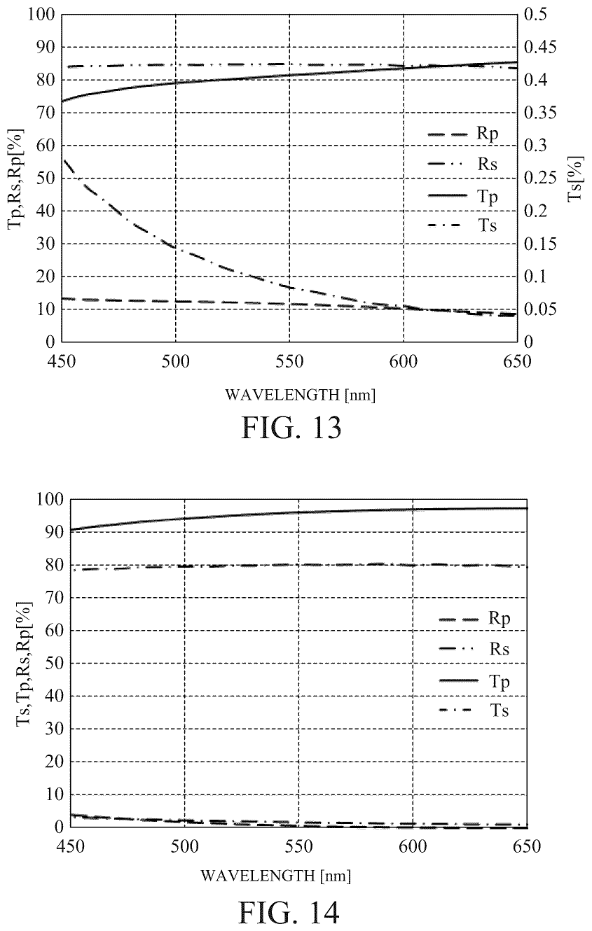

Referring now to FIGS. 12 and 13, a description will be given of a transmissive reflective element 100 (100d) according to Example 4. FIG. 12 is a side view of the transmissive reflective element 100 (100d).

The transmissive reflective element 100 (100d) has thin conductor wires 1 on a thin conductor wire surface 5 on the concave side of a base material 2 made of a plano-concave lens with a thickness of 0.8 mm. Each of the base material 2 and convex portions 3 is made of a cycloolefin copolymer. The pitch P of the convex portions 3 is 155 nm, the height h of the convex portion 3 is 180 nm, the HWFM w of the convex portion 3 is 30 nm, and the sectional shape of the convex portion 3 is rectangular.

The conductor 4 is made of aluminum. In an oblique deposition simulation at an angle of 33 degrees, the conductor 4 has a shape such that the conductor 4 is deposited on the side surface of the convex portion 3 so as to extend upward from the bottom of the concave portion in the concavo-convex structure to a portion above the convex portion 3, and the conductor 4 is deposited on the entire top surface of the convex portion 3.

The maximum height Dz of the conductor 4 in the region above the top surface of the convex portion 3 is 41.93 nm, the thickness Dx in the horizontal direction of the conductor 4 at half the height of the convex portion 3 is 27.23 nm, and a ratio between them Dx/Dz is 0.65. The maximum thickness Ax in the horizontal direction of the conductor 4 above the top surface of the convex portion 3 is 57.23 nm, and the area S of the conductor 4 on the side surface of the convex portion 3 is 0.67 nm².

FIG. 13 illustrates an RCWA result in this example, and illustrates transmittance and reflectance. In FIG. 13, since the value of s is sufficiently small, only Ts is illustrated on the right vertical axis. Based on this result, the polarization degree at a wavelength of 550 nm is calculated to be 99.80%.

### EXAMPLE 5

Referring now to FIGS. 3, 4, and 14, a description will be given of a transmissive reflective element 100 (100e) according to Example 5. The transmissive reflective element 100 (100e) according to this example, similarly to Example 1, has thin conductor wires 1 on a thin conductor wire surface 5 on one side of the base material 2 made of a flat plate with a thickness of 100 μm. Each of the base material 2 and convex portions 3 is made of a cycloolefin copolymer. The pitch P of the convex portions 3 is 130 nm, the height h of the convex portion 3 is 100 nm, the HWFM w of the convex portion 3 is 20 nm, and the sectional shape of the convex portion 3 is rectangular.

The conductor 4 is made of aluminum. In an oblique deposition simulation at an angle of 45 degrees, the conductor 4 has a shape such that the conductor 4 is deposited on the side surface of the convex portion 3 so as to extend upward from the bottom of the concave portion in the concavo-convex structure to a portion above the convex portion 3, and the conductor 4 is deposited on the entire top surface of the convex portion 3.

The maximum height Dz of the conductor 4 in the region above the top surface of the convex portion 3 is 21.21 nm, the thickness Dx in the horizontal direction of the conductor 4 at half the height of the convex portion 3 is 21.21 nm, and a ratio between them Dx/Dz is 1.00. The maximum thickness Ax in the horizontal direction of the conductor 4 above the top surface of the convex portion 3 is 41.21 nm, and the area S of the conductor 4 on the side surface of the convex portion 3 is 0.71 nm².

FIG. 14 illustrates an RCWA result in this example, and illustrates transmittance and reflectance. Based on this result, the polarization degree at a wavelength of 550 nm is calculated to be 96.27%.

### EXAMPLE 6

Referring now to FIGS. 3, 4, and 15, a description will be given of a transmissive reflective element 100 (100f) according to Example 6. Similarly to Example 1, the transmissive reflective element 100 (100f) according to this example has thin conductor wires 1 on a thin conductor wire surface 5 on one side of a base material 2 made of a flat plate with a thickness of 100 μm.

Each of the base material 2 and convex portions 3 is made of a cycloolefin copolymer. The pitch P of the convex portions 3 is 125 nm, the height h of the convex portion 3 is 170 nm, the HWFM w of the convex portion 3 is 25 nm, and the sectional shape of the convex portion 3 is rectangular.

The conductor 4 is made of aluminum. In an oblique deposition simulation at an angle of 29 degrees, the conductor 4 has a shape such that the conductor 4 is deposited on the side surface of the convex portion 3 so as to extend upward from the bottom of the concave portion in the concavo-convex structure to a portion above the convex portion 3, and the conductor 4 is deposited on the entire surface of the top surface of the convex portion 3.

The maximum height Dz of the conductor 4 in the region above the top surface of the convex portion 3 is 74.34 nm, the thickness Dx in the horizontal direction of the conductor 4 at half the height of the convex portion 3 is 41.21 nm, and a ratio between them Dx/Dz is 0.55. The maximum thickness Ax in the horizontal direction of the conductor 4 above the top surface of the convex portion 3 is 66.21 nm, and the area S of the conductor 4 on the side surface of the convex portion 3 is 0.59 nm².

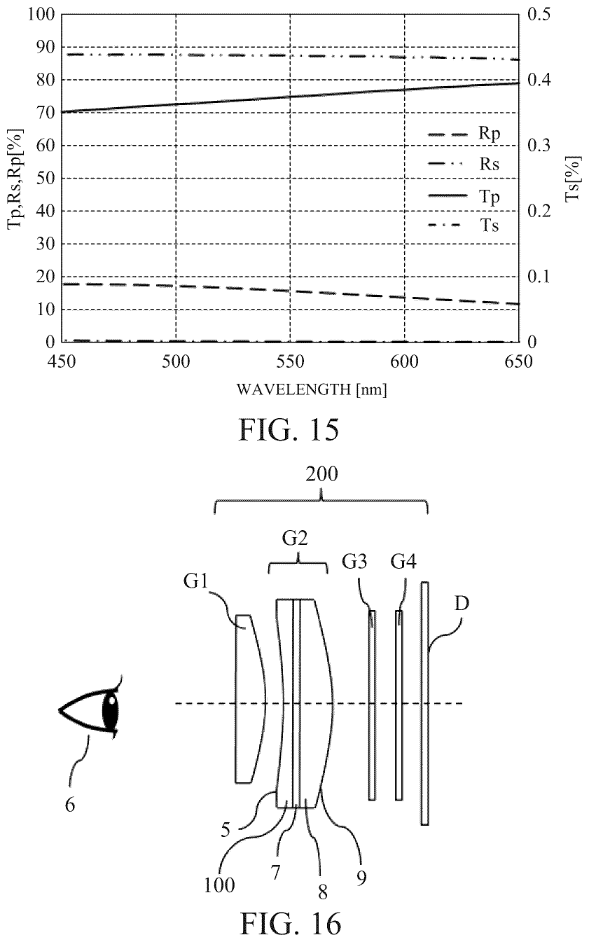

FIG. 15 illustrates an RCWA result in this example, and illustrates transmittance and reflectance. In FIG. 15, since the value of Ts is sufficiently small, only Ts is illustrated on the right vertical axis. Based on this result, the polarization degree at a wavelength of 550 nm is calculated to be 99.99%.

In this example, the value of Ax/P, which is the ratio of the maximum thickness Ax of the conductor 4 to the pitch P expressed by inequality (6), is close to the upper limit. In a case where this value is large, the transmittance decreases, but since the transmittance of S-polarized light is kept low, an excellent polarization separating function can be obtained.

Table 1 illustrates values of each inequality (IE) in each example (EX) and comparative example (CE).

TABLE 1

| | P | h | h/w | Dx | Dx/Dz | Ax/P | Dz/h | S/A |
|---|---|---|---|---|---|---|---|---|
| | IE (1) | IE (2) | IE (3) | IE (4) | IE (5) | IE (6) | IE (7) | IE (8) |
| EX 1 | 130 nm | 170 nm | 6.8 | 23.76 | 0.55 | 0.38 | 0.25 | 0.66 |
| EX 2 | 130 nm | 200 nm | 8.0 | 21.04 | 0.49 | 0.35 | 0.22 | 0.68 |
| EX 3 | 130 nm | 110 nm | 7.3 | 20.46 | 0.93 | 0.27 | 0.20 | 0.74 |
| EX 4 | 155 nm | 180 nm | 6.0 | 27.23 | 0.65 | 0.37 | 0.23 | 0.65 |
| EX 5 | 130 nm | 100 nm | 5.0 | 21.21 | 1.00 | 0.32 | 0.21 | 0.71 |
| EX 6 | 125 nm | 170 nm | 6.8 | 41.21 | 0.55 | 0.53 | 0.44 | 0.59 |
| CE | 130 nm | 60 nm | 2.4 | 25.44 | 1.60 | 0.39 | 0.26 | 0.66 |

### EXAMPLE 7

Referring now to FIG. 16, a description will be given of an optical system (optical apparatus) 200 according to Example 7. FIG. 16 is a sectional view of the optical system 200. The optical system 200 includes optical elements G1, G2, G3, G4, and display apparatus D. The optical element G1 is a refractive optical element. The optical element G2 is a joining element that includes a refractive optical element that includes the transmissive reflective element 100 in which a thin metal wire is formed on the thin conductor wire surface 5 according to any one of the above examples, a first quarter waveplate 7, and a refractive optical element 8 having a half-mirror 9 on its surface. The optical element G3 is a second quarter waveplate. The optical element G4 is a polarizing plate. The display apparatus D is an image display element such as a liquid crystal display element or an organic EL element.

Light emitted from the display apparatus D is converted into linearly polarized light by the optical element G4, is converted into circularly polarized light by the optical element G3, and enters the half-mirror 9. A portion of the light incident on the half-mirror 9 is reflected, becomes circularly polarized light that rotates in the opposite direction, and returns to the optical element G3. The reverse circularly polarized light that has returned to the optical element G3 is converted by the optical element G3 into linearly polarized light having a polarization direction orthogonal to the polarization direction when passing through the first optical element G4, and returns to the optical element G4 and is absorbed by the optical element G4.

On the other hand, the remainder of the light incident on the half-mirror 9 is transmitted through it and converted by the first quarter waveplate 7 into linearly polarized light in the same polarization direction as that when it passed through the optical element G4, and then sent to the transmissive reflective element 100. This linearly polarized light is reflected by the polarization selectivity of the transmissive reflective element 100. The light reflected by the transmissive reflective element 100 is converted by the first quarter waveplate 7 into circularly polarized light that rotates in a direction opposite to that when it is first converted into circularly polarized light by the optical element G3, and then enters the half-mirror 9.

The light reflected by the half-mirror 9 becomes circularly polarized light that rotates in a direction opposite to that of the pre-reflection light, enters the first quarter waveplate 7, and is polarized in the polarization direction when first passing through the optical element G4. The light is converted into linearly polarized light having orthogonal polarization directions and enters the transmissive reflective element 100. This linearly polarized light passes through the transmissive reflective element 100 due to its polarization selectivity and is guided to an eye 6. The image displayed on the display apparatus D is magnified and observed by a refractive optical element having power placed in the optical path of the optical system 200.

### EXAMPLE 8

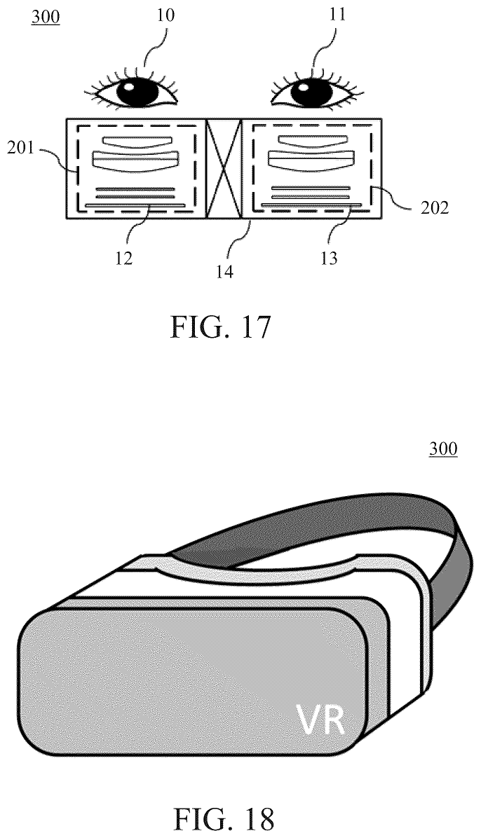

Referring now to FIGS. 17 and 18, a description will be given of an HMD (observation apparatus, optical apparatus) 300 according to Example 8. FIG. 17 is a sectional view of the HMD 300. FIG. 18 is an external view of the HMD 300.

The HMD 300 has optical systems 201 and 202. Each of the optical systems 201 and 202 has similar lens configurations, and each of the optical systems 201 and 202 is, for example, the optical system 200 according to Example 7. In FIG. 17, reference numeral 10 denotes a human's right eye, and reference numeral 11 denotes a human's left eye. The optical systems 201 and 202 are housed in a goggle-type case 14 and are disposed for the right eye 10 and the left eye 11, respectively.

The HMD 300 is used while attached to the observer's head. The optical systems 201 and 202 enable the viewer to view magnified images on display apparatuses 12 and 13. Separate images with parallax are displayed on the display apparatuses 12 and 13, thereby allowing the viewer to view a stereoscopic image.

The optical elements according to each example are obtained by the oblique deposition at a fixed angle without using any special mechanism such as a mask or swinging, and there is no need for a process to remove unnecessary parts. Therefore, each example can provide an optical element and an optical apparatus that are easy to manufacture and have high optical performance and polarization separating function.

While the disclosure has described example embodiments, it is to be understood that some embodiments are not limited to the disclosed embodiments. The scope of the following claims is to be accorded the broadest interpretation so as to encompass all such modifications and equivalent structures and functions.

Each example can provide an optical element that is easy to manufacture and has high optical performance and polarization separating function.

This application claims priority to Japanese Patent Application No.2023-081101, which was filed on May 16, 2023, and which is hereby incorporated by reference herein in its entirety.

What is claimed is:

1. An optical element comprising:
a base material having a plurality of convex portions arranged along a first direction; and
a conductor provided to each of the plurality of convex portions,
wherein each of the plurality of convex portions extends in a second direction perpendicular to the first direction,
wherein in a section including the first direction and a third direction perpendicular to each of the first direction and the second direction, each of the plurality of convex portions has a rectangular shape, and
wherein the following inequalities are satisfied:
$$125 \leq P \leq 160$$
$$0.45 \leq Dx / Dz \leq 1.2$$
where P (mm) is an arrangement pitch of the plurality of convex portions, Dz (nm) is a distance in the third direction from a top surface of each convex portion in the section to a top surface of the conductor provided to each convex portion, and Dx (nm) is a thickness of the conductor in the first direction at half a height in the third direction of each convex portion.

2. The optical element according to claim 1, wherein the conductor covers at least a part of one side and the top surface of each of the plurality of convex portions in the section.

3. The optical element according to claim 1, wherein the following inequality is satisfied:
20.00≤Dx.

4. The optical element according to claim 1, wherein the following inequality is satisfied:
$$4.0 \leq h / w \leq 9.0$$
where h (nm) is a height in the third direction of the convex portion, and w (nm) is a width of the convex portion at half a height of the convex portion.

5. The optical element according to claim 1, wherein the following inequality is satisfied:
$$0.15 \leq Dz / h \leq 0.60$$
where h (nm) is a height in the third direction of the convex portion.

6. The optical element according to claim 1, wherein the following inequality is satisfied:
$$0.5 \leq S / A$$
where A is an entire sectional area of the conductor in the section, and S is a sectional area of a portion of the conductor deposited on a side surface of the convex portion in the section.

7. The optical element according to claim 1, wherein the following inequality is satisfied:
$$0.25 \leq Ax / P \leq 0.60$$
where Ax (nm) is a maximum thickness of the conductor in the first direction above the convex portion in the section.

8. The optical element according to claim 1, wherein the conductor covers 60% or more of the top surface of the convex portion in the section.

9. The optical element according to claim 1, wherein the base material is a flat plate or a lens having a curved surface with a thickness on an optical axis of 100 μm or more.

10. The optical element according to claim 1, wherein the plurality of convex portions is made of a thermoplastic resin.

11. The optical element according to claim 1, wherein the following inequality is satisfied:
100 ≤ h where h (nm) is a height in the third direction of the convex portion.

12. An optical apparatus comprising a plurality of optical elements, wherein at least one of the plurality of optical elements includes:
a base material having a plurality of convex portions arranged along a first direction; and
a conductor provided to each of the plurality of convex portions, wherein each of the plurality of convex portions extends in a second direction perpendicular to the first direction, wherein in a section including the first direction and a third direction perpendicular to each of the first direction and the second direction, each of the plurality of convex portions has a rectangular shape, and wherein the following inequalities are satisfied:
$$125 \leq P \leq 160$$
$$0.45 \leq Dx / Dz \leq 1.2$$
where P (mm) is an arrangement pitch of the plurality of convex portions, Dz (nm) is a distance in the third direction from a top surface of each convex portion in the section to a top surface of the conductor provided to each convex portion, and Dx (nm) is a thickness of the conductor in the first direction at half a height in the third direction of each convex portion.
